(19) United States
(12) Patent Application Publication
(10) Pub. No.: US 2017/0322928 A1
(43) Pub. Date: Nov. 9, 2017

(54) EXISTING ASSOCIATION REVIEW PROCESS DETERMINATION UTILIZING ANALYTICS DECISION MODEL

(71) Applicants: Stanislav Ivanov Gotchev, Bloomfield, CT (US); Lucas Raymond Roberts, New York, NY (US); Elizabeth Puchir Sheldon, New York, NY (US); Michael O. Wardle, Frankfort, NY (US)

(72) Inventors: Stanislav Ivanov Gotchev, Bloomfield, CT (US); Lucas Raymond Roberts, New York, NY (US); Elizabeth Puchir Sheldon, New York, NY (US); Michael O. Wardle, Frankfort, NY (US)

(21) Appl. No.: 15/146,238

(22) Filed: May 4, 2016

(51) Int. Cl. G06F 17/30; G06Q 40/08

(52) U.S. Cl. CPC G06F 17/30011; G06F 17/3053; G06Q 40/08

(57) ABSTRACT

A system may automatically identify electronic records to be routed to an existing association review process via an automated back-end application computer server. The system may include a data store containing a set of electronic records, each record representing an existing risk association with an entity, and each record may contain a record identifier and a set of record characteristic values, including at least one record characteristic value collected during the existing risk association. The computer server may then access the electronic records and automatically create, by an analytics decision model based on the record characteristic values, a subset of the records for the review process. An indication of the existing association review process subset may then be transmitted in connection with an interactive user interface display and records in the subset may be automatically routed for the existing association review process.

### BACKGROUND

Electronic records, such as files and database entries, may be stored and utilized by an enterprise. Moreover, an enterprise may be interested in analyzing information about each electronic record to determine if a “renewal” referral process should be performed for that particular record (e.g., to renew or otherwise extend an existing, active relationship with an entity). For example, the enterprise might want to identify which electronic records would most benefit from such an existing association review process. Manually analyzing a batch of electronic records (e.g., each representing an existing risk association with a different entity) to identify which ones might most benefit from the existing association review process, however, can be a time consuming and error prone process—especially where there are a substantial number of records to be analyzed (e.g., thousands of new electronic records might need to be analyzed each week while available resources might only allow a relatively small number of those records to be reviewed) and/or there are many factors that could potentially influence whether or not each record would benefit from the existing association review process.

It would be desirable to provide systems and methods to automatically utilize an analytics decision model that generates faster, more accurate identifications of electronic records for an existing association review process and that allows for flexibility and effectiveness when reviewing those identifications.

### SUMMARY OF THE INVENTION

According to some embodiments, systems, methods, apparatus, computer program code and means automatically identify electronic records to be routed to an existing association review process. In some embodiments, a system may automatically identify electronic records to be routed to an existing association review process via an automated back-end application computer server. The system may include a data store containing a set of electronic records, each electronic record representing an existing risk association with an entity, and each electronic record may contain a record identifier and a set of record characteristic values, including at least one record characteristic value collected during the existing risk association. The computer server may then access the electronic records and automatically create, by an analytics decision model based on the record characteristic values, a subset of the set of electronic records for an existing association review process. An indication representing the existing association review process subset may be transmitted in connection with an interactive user interface display and it may be arranged for electronic records in the existing association review process subset to be automatically routed such that those electronic records will undergo the existing association review process.

Some embodiments comprise: means for accessing a data store containing a set of electronic records, each electronic record representing an existing risk association with an entity, wherein each electronic record contains a record identifier and a set of record characteristic values, including at least one record characteristic value collected during the existing risk association; means for automatically creating, by an analytics decision model based on the record characteristic values, a subset of the set of electronic records for an existing association review process; means for transmitting an indication representing the existing association review process subset in connection with an interactive user interface display; and means for arranging for electronic records in the existing association review process subset to be automatically routed such that those electronic records will undergo the existing association review process.

In some embodiments, a communication device associated with a back-end application computer server exchanges information with remote devices. The information may be exchanged, for example, via public and/or proprietary communication networks.

Technical effects of some embodiments of the invention are improved and computerized ways to utilize an analytics decision model that generates faster, more accurate identifications of electronic records for an existing association review process and that allows for flexibility and effectiveness when reviewing those identifications. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is a process flow in accordance with some embodiments of the present invention.

FIG. 4 is a process timeline according to some embodiments.

FIG. 5 is a high-level block diagram of an insurance enterprise system according to some embodiments of the present invention.

FIG. 6 illustrates an exemplary result monitoring display that might be associated with various embodiments.

FIG. 7 illustrates an exemplary model monitoring display according to some embodiments of the present invention.

FIG. 8 is a block diagram of an apparatus in accordance with some embodiments of the present invention.

FIG. 9 is a portion of a tabular existing association review database in accordance with some embodiments.

FIG. 10 illustrates a system having a predictive model in accordance with some embodiments.

FIG. 11 illustrates a tablet computer displaying a ranked list of model outputs according to some embodiments.

FIG. 12 illustrates an overall enterprise workflow in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record analysis by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be transmitted to remote devices from a back-end application server and electronic records may be routed for an existing association review process as appropriate, thus improving the overall performance of the system associated with message storage requirements and/or bandwidth considerations (e.g., by reducing the number of messages that need to be transmitted via a network). Moreover, embodiments associated with automatic predictions might further improve communication network performance, user interactions, real time chat or telephone call center responsiveness (e.g., by better preparing and/or allocating representatives), etc.

Electronic records, such as files and database entries, may be stored and utilized by an enterprise. Moreover, an enterprise may be interested in analyzing information about each electronic record to determine if a “renewal” referral process should be performed for that particular record. As used herein, the term “new” might refer to renewing or otherwise extending an existing, active relationship with an entity (e.g., under identical or modified terms and conditions). For example, the enterprise might want to identify which electronic records would most benefit from such an existing association review process. Manually analyzing a batch of electronic records to identify which ones might most benefit from the existing association review process, however, can be a time consuming and error prone process—especially where there are a substantial number of records to be analyzed (e.g., thousands of electronic records might need to be analyzed) and/or there are many factors that could potentially influence whether or not each record would benefit from the existing association review process.

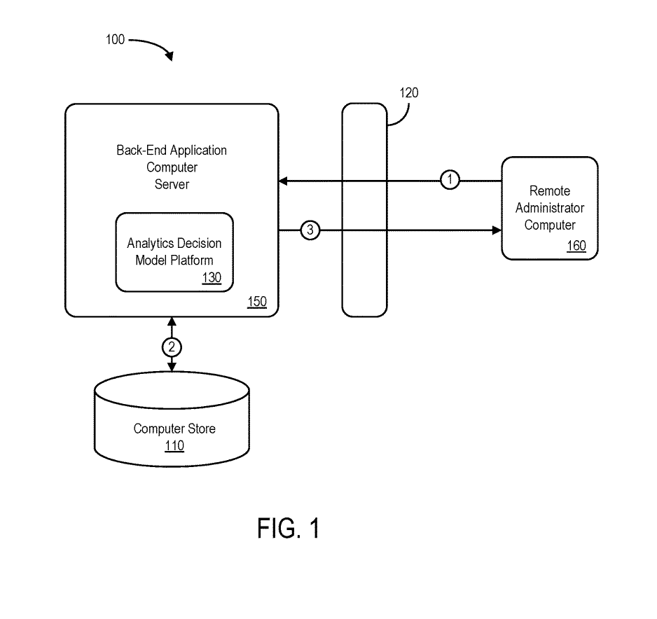

It would be desirable to provide systems and methods to utilize an analytics decision model that generates faster, more accurate identifications of electronic records for an existing association review process and that allows for flexibility and effectiveness when reviewing those identifications. FIG. 1 is a high-level block diagram of a system 100 according to some embodiments of the present invention. In particular, the system 100 includes a back-end application computer server 150 that may access information in a computer store 110 (e.g., storing a set of electronic records representing existing risk associations, each record including one or more communication addresses, attribute variables, record characteristic values, etc.). The back-end application computer server 150 may also exchange information with a remote administrator computer 160 (e.g., via a firewall 120). According to some embodiments, an analytics decision model platform 130 of the back-end application computer server 150 may recommend a subset of electronic records to be routed to an existing association review process and the display/review of those recommendations via one or more remote administrator computers 160. Note that embodiments may be associated with periodic (or asynchronous) types of review, evaluation, and/or scheduling. Further note that the back-end application computer server 150 might be associated with a third-party, such as a vendor that performs a service for an enterprise.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may automatically create a subset of the records in the computer store 110 for further evaluation or review. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might, for example, store a set of electronic records representing existing risk associations with entities, each electronic record being associated with a different record identifier, communication address, record characteristic values, and/or attribute variables. The computer store 110 may also contain information about past and current interactions with parties, including those associated with remote communication devices. The computer store 110 may be locally stored or reside remote from the back-end application computer server 150. As will be described further below, the computer store 110 may be used by the back-end application computer server 150 to automatically determine if an existing association review process might be appropriate for a particular electronic record. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may automatically route electronic records for an existing association review process via the automated back-end application computer server 150. For example, at (1) the remote administrator computer 160 may request that a batch of electronic records be analyzed to automatically determine which ones might most benefit from an existing association review process. The analytics decision model platform 130 may then access information in the computer store 110 at (2) and exchange information with the administrator at (3) to support an interactive user interface display (e.g., including an indication of a subset of records that should undergo the existing association review process). The system 100 might also automatically transmit information about the subset of electronic records to the remote administrator computer 160 and/or an existing association review process workstation or platform (not illustrated in FIG. 1).

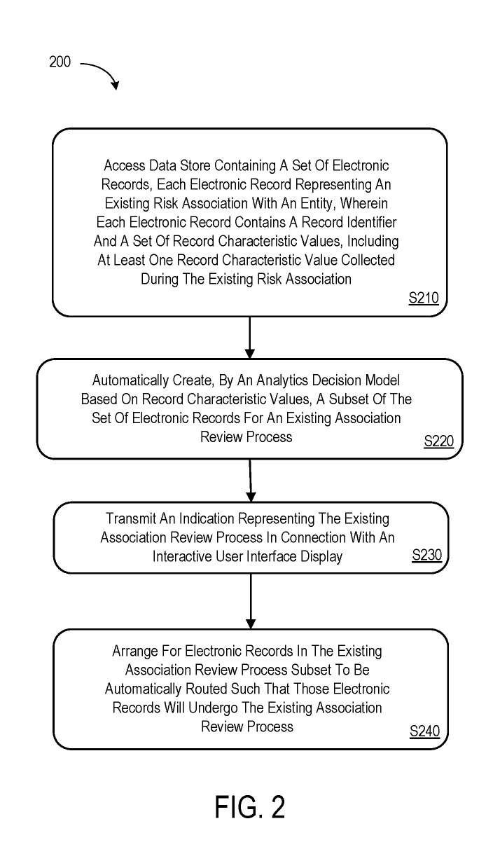

Note that the system 100 of FIG. 1 is provided only as an example, and embodiments may be associated with additional elements or components. According to some embodiments, the elements of the system 100 automatically support interactive user interface displays over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an automated back-end application computer server may access a data store containing a set of electronic records, each electronic record representing an existing risk association with an entity, wherein each electronic record contains a record identifier and a set of record characteristic values, including at least one record characteristic value collected during the existing risk association. At S220, the system may automatically create, by an analytics decision model based on the record characteristic values, a subset of the set of electronic records for an existing association review process. At S230, an indication representing the existing association review process subset may be transmitted in connection with an interactive user interface display. At S240, the system may arrange for electronic records in the existing association review process subset to be automatically routed such that those electronic records will undergo the existing association review process.

As used herein, an “analytics decision” model may be associated with an approach that utilizes statistics and analytics to create accurate predictions. The analytics decision model might encompass a variety of statistical techniques (e.g., modeling, machine learning, data mining, etc.) that analyze current and historical facts to make predictions about future events (e.g., the effectiveness of an existing association review process). The term “analytics” may refer to the use of skills, technologies, and/or practices to explore and investigate past performance, gain insight, and/or drive decision making. By using quantitative metrics and analysis, a decision model may help make more accurate decisions and better predict risks associated with those decisions and associated entities.

Note that the indication of the existing association review process subset generated by the analytics decision model might comprise a binary indication flagging each record (with records receiving a “1” being included in the subset for existing association review). As another example, an existing association review process numerical score or value might be calculated (e.g., from 0 through 100). In this case, all records receiving a score above a threshold value might be routed for the existing association review process, the first X records receiving the highest scores might be routed for the existing association review or the top Y percent of records might be included in the subset, etc.

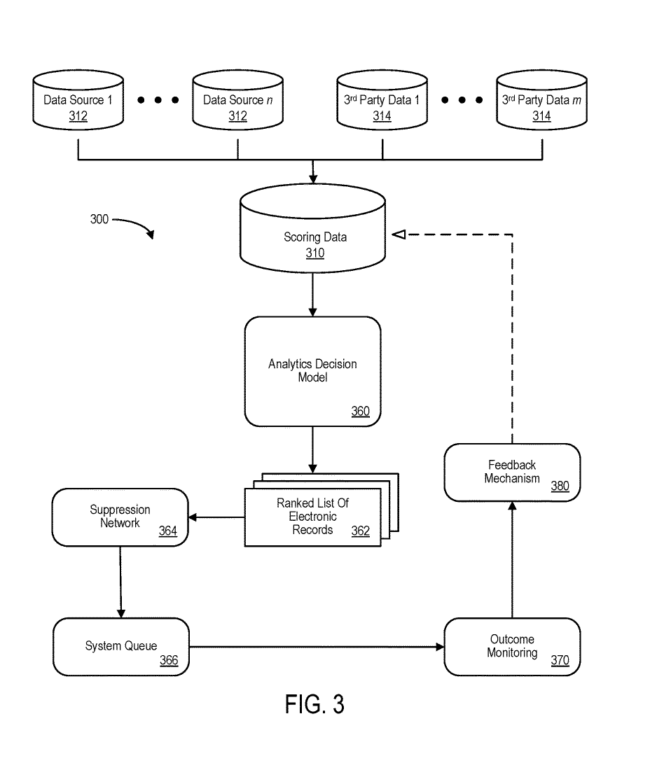

FIG. 3 is a process flow 300 in accordance with some embodiments of the present invention. Initially, data may be collected and stored into data sources 1 through n 312 (e.g., internal to an enterprise) and/or third-party data elements 1 through m 314 (e.g., external to the enterprise). Information from the internal data sources 312 and third-party data elements 314 may be combined at a single scoring data 310 storage unit. For example, the scoring data 310 might comprise a set of electronic records, each record being associated with an existing risk association with an entity and including a record identifier and a set of record characteristic values (e.g., based on the data sources 312 and third-party data elements 314).

According to some embodiments, information from the scoring data 310 may be fed into an analytics decision model 360. The outputs of this model 360 may then be a ranked list of electronic records 362 that identify which electronic records in the scoring data 310 would most benefit from an existing association review process or procedure (e.g., in situations where it is not practical to perform the existing association review process for each and every electronic record in the scoring data 310). The list 362 might be ranked, for example, beginning with those electronic records that are most likely to benefit from the existing association review process and end with those electronic records that are least likely to benefit from the existing association review process. According to other embodiments, the analytics decision model 360 instead outputs a list of only those electronic records that would benefit from the existing association review process. A suppression network 364 may execute record suppression logic to remove at least some of the electronic records from the existing association review process subset based on a previously performed existing association review process. For example, if an electronic record had undergone the existing association review process twelve months ago (and nothing substantial had changed in the meantime), the suppression network 364 might automatically remove that record from the subset. According to other embodiments, the suppression network 364 might rearrange at least some the electronic records instead of removing them.

The remaining electronic records from the suppression network 364 may then be processed via a system queue 366 (e.g., with a sub-set of the records undergoing the existing association review process). Outcome monitoring 370 and/or a feedback mechanism 380 may then be used to fine tune the scoring data 310 and/or the model 360 such that more accurate results might be achieved in the future (e.g., those records that actually will benefit from the existing association review process may be more readily and accurately identified by the process flow 300).

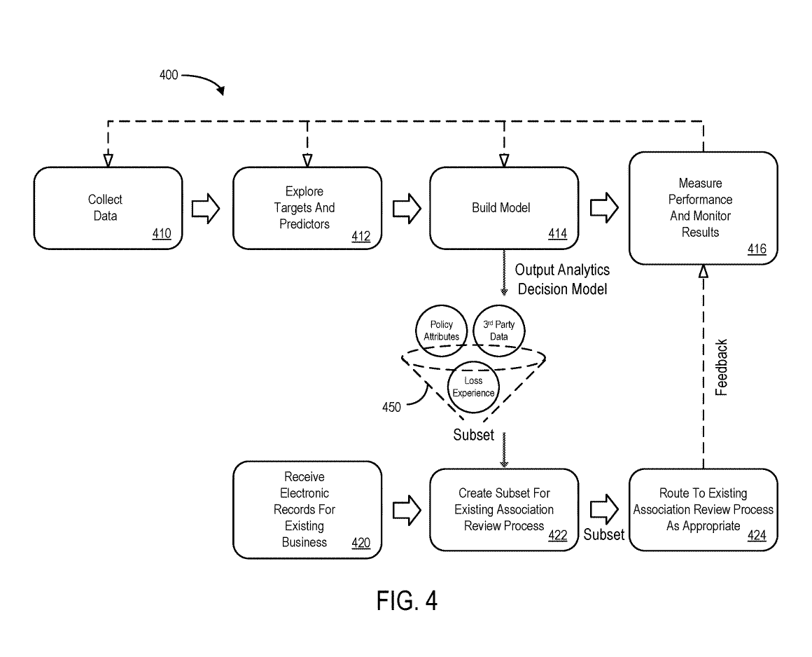

FIG. 4 is a process timeline 400 according to some embodiments. At 410, data may be collected. The collected data might, for example, be associated with prior risk associations, record characteristic values, and/or outcomes (e.g., performance values and/or results of past existing association review processes). At 412, targets and predictors may be explored and an analytics decision model 450 may be built at 414 and output. For example, based on the policy attributes, third-party data, and loss experience, it might be automatically determined that one or more record characteristic values tend to accurately predict eventual existing association review process results. At 420, one or more electronic records may be received and the analytics decision model 450 may be used to create subset of the electronic records that should undergo the existing association review process at 422. The subset of electronic records may then be automatically routed for review as appropriate at 424. Moreover, the results of that review process may be used to measure the performance (e.g., accuracy) of the analytics decision model and/or to monitor overall system results at 416. The results of these measurements and monitoring may then be used to adjust and/or re-analyze collected data, targets and predictors, and/or the analytics decision model to improve the overall operation and performance of the system.

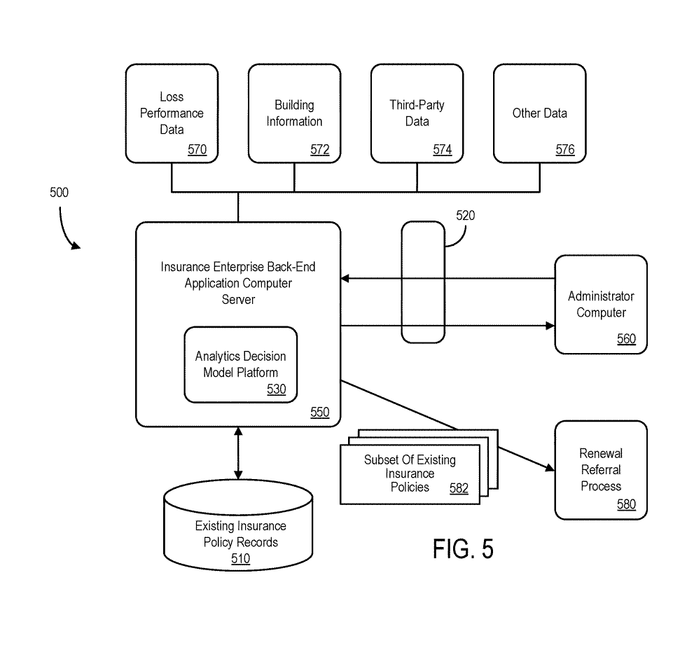

Note that embodiments described herein may be utilized by different types of enterprises. For example, FIG. 5 is a high-level block diagram of an insurance enterprise system 500 according to some embodiments of the present invention. As before, the system 500 includes an insurance enterprise back-end application computer server 550 that may access a set of existing, active insurance policy records 510 (e.g., each record representing an existing insurance policy and including one or more communication addresses, characteristic values, attribute variables, etc.). The back-end application computer server 550 may also exchange information with a remote administrator computer 560 (e.g., via a firewall 520). According to some embodiments, an analytics decision model platform 530 of the back-end application computer server 550 may facilitate a creation of a subset of existing insurance policies (e.g., those that would most benefit from a renewal referral underwriting evaluation) and/or the display of results via one or more remote administrator computers 560. The back-end application computer server 550 might be, for example, associated with a PC, laptop computer, smartphone, an enterprise server, a server farm, and/or a database or similar storage devices. Devices, including those associated with the back-end application computer server 550 and any other device described herein, may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet.

The back-end application computer server 550 may store information into and/or retrieve information from the insurance policy records 510. The existing insurance policy records 510 might, for example, store insurance policy identifiers, communication addresses, characteristic values (e.g., a building construction type, a number of previously submitted claims, a building age, etc.), and/or attribute variables. The existing insurance policy records 510 may also contain information about past and current interactions with parties, including those associated with remote communication devices. According to this embodiment, the computer server 550 may also exchange information with a distribution center (e.g., to arrange for postal mailing to be distributed and collected in connection with an insurance policy renewal quote process), a telephone call center (e.g., to arrange for telephone calls to be made in connection with renewal insurance quotes), an email server, a third-party data device (e.g., to receive business credit score data, governmental information, etc.), and/or one or more predictive models.

Thus, some embodiments are associated with existing risk associations (existing insurance policies) with entities (existing insureds). Those existing insurance policies 582 in the subset created by the analytics decision model platform 530 may then be automatically routed for underwriter evaluation via a renewal referral process 580.

According to some embodiments, at least some of the set of record characteristic values are associated with loss performance data 570 (e.g., past loss experience in terms of frequency and/or severity). At least some of the set of record characteristic value may be associated with building information 572 (e.g., construction type, occupancy, protection class, square footage, age of building, etc.). Third-party data 574 might also be utilized (e.g., business credit data, geodemographic data, social media information, economic indicators, and/or macro-economic indicators). Note that other data 576 could include, for example, vehicle information (e.g., vehicles classified as trucks, tractors, trailers, etc., weights, radius of operation, use, etc.), employee/driver information (e.g., higher hazard workers' compensation class codes, Motor Vehicle Reports (“MVRs”), telematics, Usage Based Insurance (“UBI” data, etc.), measures of insurance policy complexity (e.g., industry classification, premium size, coverage composition, multiple lines of business, years of association with entity, number of states, locations, etc.), indicators of change over time (e.g., endorsement activity, such as additions of locations or vehicles and amending class codes, claim indictors, etc.), geographic information (e.g., state, county, ZIP code, etc.), and/or billing/payment characteristics (e.g., billing method, payment method, payment frequency, payment history, etc.). According to some embodiments, at least some of the record characteristic values represent other types of insurance, such as workers' compensation insurance, disability insurance, general liability insurance, etc.

Record characteristic values may be collected in a number of different ways. For example, each electronic record (e.g., existing insurance policy record 510) may be associated with a record identifier and a communication address, and the sets of record characteristic values might be collected by sending a communication to that communication address and receiving, from a party associated with an electronic record having that communication address, a response to the communication. Note that a postal mailing might be automatically generated and/or received by a distribution center, an email might be automatically generated by an email server, information could be provided and/or collected via: a web interface, an Interactive Voice Response (“IVR”) system associated with a telephone call center, a chat application that interacts with a party in substantially real time, and/or a video link (e.g., with an insurance agent or underwriter). According to some embodiments, after the existing insurance policies 582 are identified for the underwriter evaluation 580), the back-end application computer server 550 is further to periodically monitor performance outcomes and automatically adjust the analytics decision model (e.g., to improve outcomes, risk profitability, risk quality, policy growth, etc.). The performance outcomes might be associated with, for example, a Do Not Renew (“DNR”) decision, endorsement activity (e.g., limiting risk associated with a particular insurance policy), a renew per existing policy indication, and/or a renew with changes indication.

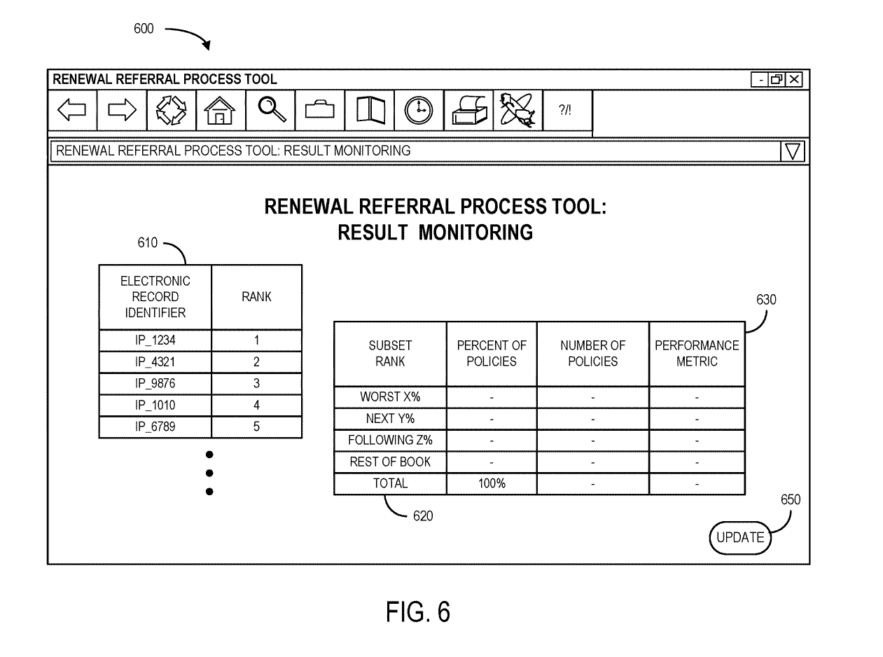

FIG. 6 illustrates an exemplary result monitoring display 600 (e.g., associated with renewal referral process recommendations) that might be associated with various embodiments described herein. The display 600 includes a ranked list 610 of existing insurance policies up for renewal, including an electronic record identifier and a rank value for each policy (e.g., with a subset of the first 3% of the policies in the list 610 being targeted for the renewal referral process). The display 600 further includes summary information 620, including a subset rank, a percent of policies and number of policies associated with that subset rank. The summary information may further include a performance metric 630 for each subset rank. According to some embodiments, the display 600 may be interactive (e.g., a user may select items on the display 600 to receive further details about that item, adjust parameter values, etc.). The display 600 might be generated and/or updated, for example, upon selection of an update icon 650 by an underwriter and might be used to evaluate an existing insurance policy and/or the operation of the analytics decision model.

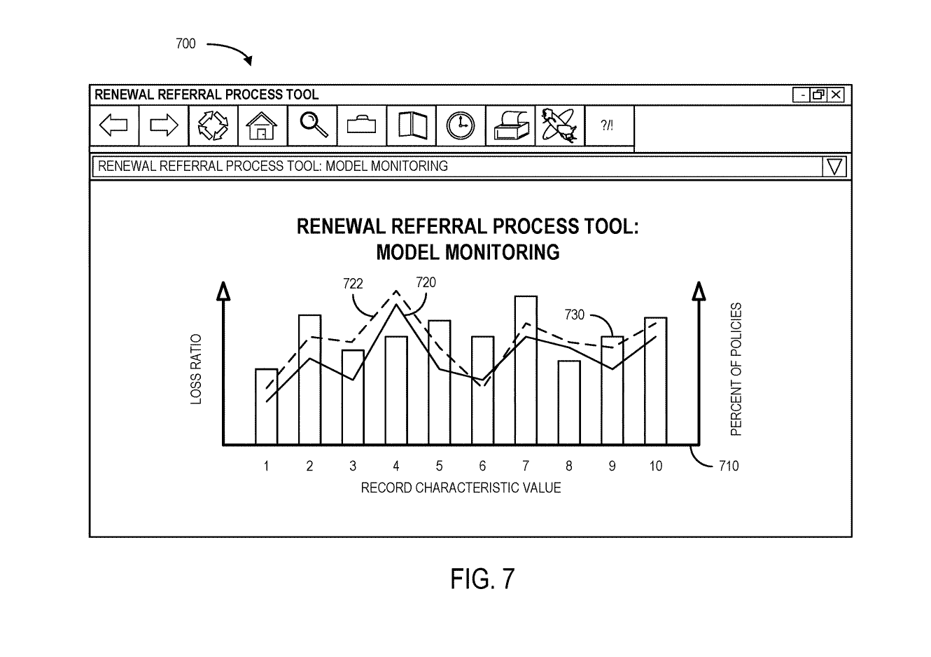

FIG. 7 illustrates a model monitoring display 700 in accordance with embodiments described herein. The display 700 includes a graph 710 associated with various values for a record characteristic. Although the graph 710 of FIG. 7 illustrates ten characteristic values as an example, note that embodiments may be associated with any number of such values. For each value, the graph 710 plots an actual performance metric, such as a loss ratio 720 (e.g., reflecting actual claim losses), a predicted model performance metric, such as a predicted model loss ratio 722, and bars 730 reflecting a percentage of the overall number of insurance policies (e.g., with all of the bars 730 adding up to 100%). The actual loss ratio 720, predicted model loss ratio 722, and bars 730 may be used by an administrator to help determine if a model is generating appropriate results (e.g., that the actual and predicted loss ratios 720, 722 make sense).

Thus, some embodiments may help optimize an existing business referral process to identify “at risk” insurance policies for further review. For example, those policies most likely to result in a DNOC or endorsement (given the submitted policy characteristics) may be automatically identified. Moreover, embodiments may provide a mechanism to utilize internal and/or third-party information as a means to identify predictive elements or situations within a policy and rank the policies based on desired outcomes. Such an approach may let an insurance entity understand, leverage, and drive continuity within rules associated across new business, mid-term, and renewal business. According to some embodiments, the underwriting scoring models described herein may help focus resources on policies where attention will have the largest impact on the book of insurance business. The models may represent amalgamations of factors, including those driving higher risk, dynamic underwriting exposure concerns, and/or agency characteristics. Further, some embodiments may allow for the prioritization of scarce underwriting capacity such that underwriters can have the most impact.

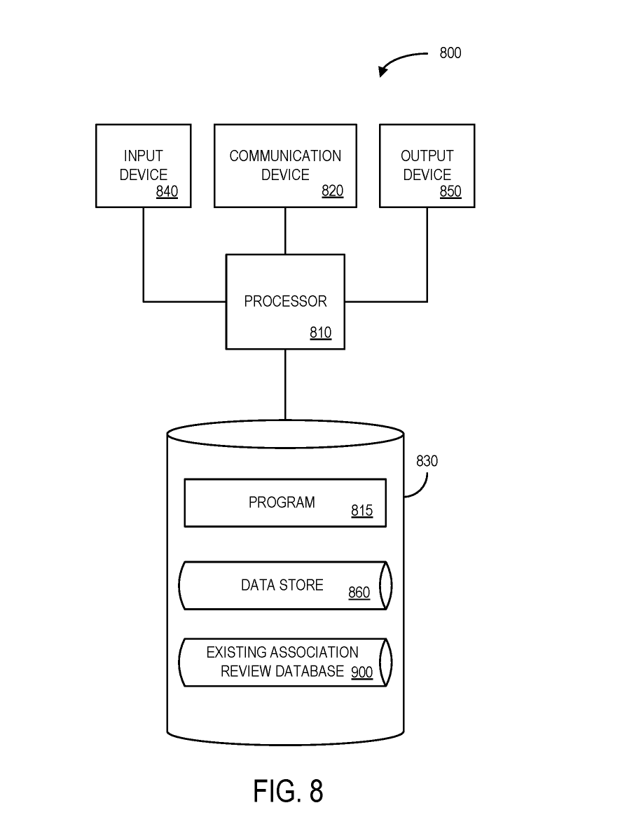

Embodiments described herein may comprise a tool that gives guidance (and a suggested list of existing insurance policies for further evaluation) to an underwriter and may be implemented using any number of different hardware configurations. For example, FIG. 8 illustrates a back-end application computer server 800 that may be, for example, associated with the systems 100, 500 of FIGS. 1 and 5, respectively. The back-end application computer server 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote administrator or underwriter computers and/or communication devices (e.g., PCs and smartphones). Note that communications exchanged via the communication device 820 may utilize security features, such as those between a public internet user and an internal network of the insurance enterprise. The security features might be associated with, for example, web servers, firewalls, and/or PCI infrastructure. The back-end application computer server 800 further includes an input device 840 (e.g., a mouse and/or keyboard to enter information about existing insurance policies, historic information, analytics decision models, etc.) and an output device 850 (e.g., to output reports regarding system administration and/or underwriting review performance).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 815 and/or an existing association review tool or application for controlling the processor 810. The processor 810 performs instructions of the program 815, and thereby operates in accordance with any of the embodiments described herein. For example, the processor 810 may automatically create a subset of electronic records to be routed to an existing association review process via an automated back-end application computer server. In particular, the processor 810 might access a data store containing a set of electronic records, each electronic record representing an existing risk association with an entity, and each electronic record may contain a record identifier and a set of record characteristic values, including at least one record characteristic value collected during the existing risk association. The processor 810 may then automatically generate, by an analytics decision model based on the record characteristic values, a subset of the set of electronic records for the existing association review process. An indication representing the existing association review process subset may be transmitted by the processor 810 in connection with an interactive user interface display, and the processor 810 may arrange for electronic records in the existing association review process subset to be automatically routed (e.g., via the communication device 820) such that those electronic records will undergo the existing association review process.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the back-end application computer server 800 from another device; or (ii) a software application or module within the back-end application computer server 800 from another software application, module, or any other source.

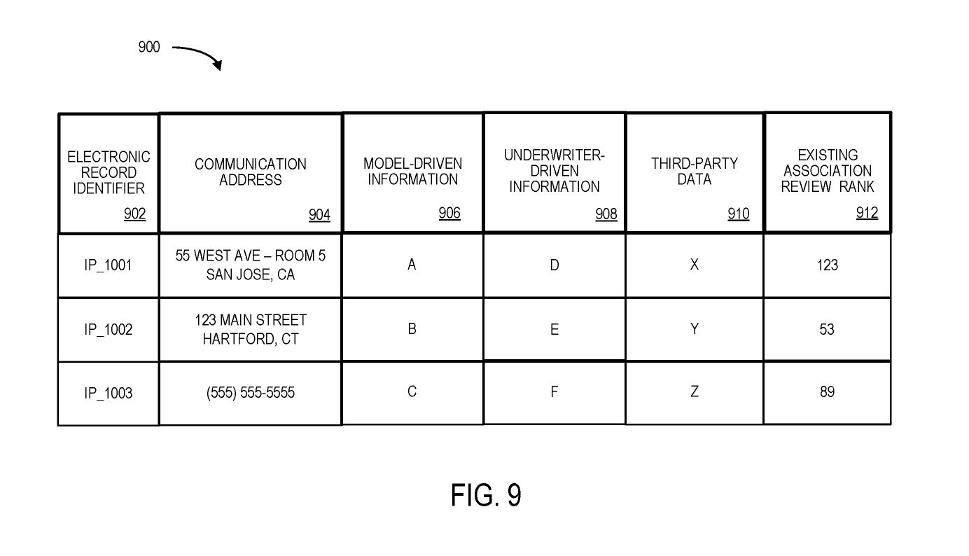

In some embodiments (such as shown in FIG. 8), the storage device 830 further stores a computer data store 860 (e.g., associated with a set of destination communication addresses, record characteristic values, attribute variables, etc.) and an existing association review database 900. An example of a database that might be used in connection with the back-end application computer server 800 will now be described in detail with respect to FIG. 9. Note that the database described herein is only an example, and additional and/or different information may be stored therein. Moreover, various databases might be split or combined in accordance with any of the embodiments described herein. For example, the computer data store 860 and/or existing association review database 900 might be combined and/or linked to each other within the program 815.

Referring to FIG. 9, a table is shown that represents the existing association review database 900 that may be stored at the back-end application computer server 800 according to some embodiments. The table may include, for example, entries identifying existing insurance policies. The table may also define fields 902, 904, 906, 908, 910, 912 for each of the entries. The fields 902, 904, 906, 908, 910, 912 may, according to some embodiments, specify: an electronic record identifier 902, a communication address 904, model-driven information 906, underwriter-driven information 908, third-party data 910, and an existing association review rank 912. The existing association review database 900 may be created and updated, for example, based on information electrically received from a computer data store and/or an insurance underwriter or agent.

The electronic record identifier 902 may be, for example, a unique alphanumeric code identifying an existing insurance policy up for renewal and the communication address 904 might be used to collect information about that insurance policy (e.g., a type of business, whether or not umbrella coverage exists, etc.). The collected information might include internal (e.g., to an insurance enterprise) and/or external data such as the model-driven information 906, underwriter-driven information 908, and third-part data 910. This collected information may then be used by the analytics decision model to automatically generate the existing association review rank 912 (e.g., which may define a subset of electronic records that should be routed to an existing association review process or platform).

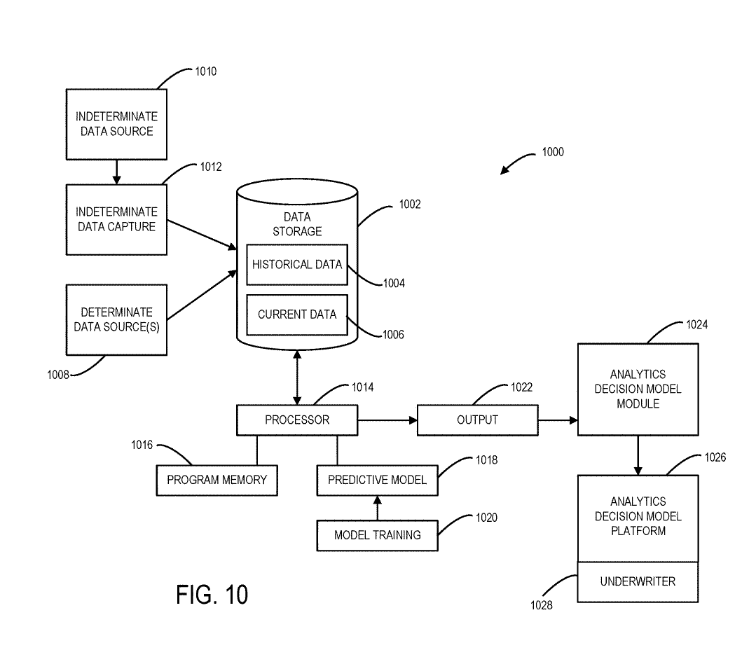

According to some embodiments, one or more predictive models (e.g., decision models) may be used to select, create, update, route, and/or evaluate electronic records. Features of some embodiments associated with a predictive model will now be described by first referring to FIG. 10. FIG. 10 is a partially functional block diagram that illustrates aspects of a computer system 1000 provided in accordance with some embodiments of the invention. For present purposes it will be assumed that the computer system 1000 is operated by an insurance company (not separately shown) for the purpose of supporting insurance policy renewals (e.g., to determine which insurance policies should be evaluated by an underwriter).

The computer system 1000 includes a data storage module 1002. In terms of its hardware the data storage module 1002 may be conventional, and may be composed, for example, by one or more magnetic hard disk drives. A function performed by the data storage module 1002 in the computer system 1000 is to receive, store and provide access to both historical transaction data (reference numeral 1004) and current transaction data (reference numeral 1006). As described in more detail below, the historical transaction data 1004 is employed to train a predictive model to provide an output that indicates an identified performance metric (e.g., whether an existing association review process is appropriate) and/or an algorithm to score performance factors, and the current transaction data 1006 is thereafter analyzed by the predictive model. Moreover, as time goes by, and results become known from processing current transactions (e.g., underwriting decisions made in connection with other insurance policies), at least some of the current transactions may be used to perform further training of the predictive model. Consequently, the predictive model may thereby appropriately adapt itself to changing conditions.

Either the historical transaction data 1004 or the current transaction data 1006 might include, according to some embodiments, determinate and indeterminate data. As used herein and in the appended claims, “determinate data” refers to verifiable facts such as the an age of a business; an business type; a policy date or other date; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech, text, image, video, and/or audio information in descriptive notes fields and signal characteristics in audible voice data files.

The determinate data may come from one or more determinate data sources 1008 that are included in the computer system 1000 and are coupled to the data storage module 1002. The determinate data may include “hard” data like an existing insured's name, date of establishment, industry code, keywords and phrases, policy number, address, an underwriter decision, etc. One possible source of the determinate data may be the insurance company's policy database (not separately indicated).

The indeterminate data may originate from one or more indeterminate data sources 1010, and may be extracted from raw files or the like by one or more indeterminate data capture modules 1012. Both the indeterminate data source(s) 1010 and the indeterminate data capture module(s) 1012 may be included in the computer system 1000 and coupled directly or indirectly to the data storage module 1002. Examples of the indeterminate data source(s) 1010 may include data storage facilities for document images, for text files, and digitized recorded voice files. Examples of the indeterminate data capture module(s) 1012 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1000 also may include a computer processor 1014. The computer processor 1014 may include one or more conventional microprocessors and may operate to execute programmed instructions to provide functionality as described herein. Among other functions, the computer processor 1014 may store and retrieve historical insurance transaction data 1004 and current transaction data 1006 in and from the data storage module 1002. Thus the computer processor 1014 may be coupled to the data storage module 1002.

The computer system 1000 may further include a program memory 1016 that is coupled to the computer processor 1014. The program memory 1016 may include one or more fixed storage devices, such as one or more hard disk drives, and one or more volatile storage devices, such as RAM devices. The program memory 1016 may be at least partially integrated with the data storage module 1002. The program memory 1016 may store one or more application programs, an operating system, device drivers, etc., all of which may contain program instruction steps for execution by the computer processor 1014.

The computer system 1000 further includes a predictive model component 1018. In certain practical embodiments of the computer system 1000, the predictive model component 1018 may effectively be implemented via the computer processor 1014, one or more application programs stored in the program memory 1016, and computer stored as a result of training operations based on the historical transaction data 1004 (and possibly also data received from a third-party). In some embodiments, data arising from model training may be stored in the data storage module 1002, or in a separate computer store (not separately shown). A function of the predictive model component 1018 may be to determine appropriate underwriting evaluation routing decisions for a set of existing insurance policies up for renewal. The predictive model component may be directly or indirectly coupled to the data storage module 1002.

The predictive model component 1018 may operate generally in accordance with conventional principles for mixed effect predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a mixed or fixed effect predictive model, a generalized linear model, and/or any other form of predictive model to operate as described herein.

Still further, the computer system 1000 includes a model training component 1020. The model training component 1020 may be coupled to the computer processor 1014 (directly or indirectly) and may have the function of training the predictive model component 1018 based on the historical transaction data 1004 and/or information about existing insureds. (As will be understood from previous discussion, the model training component 1020 may further train the predictive model component 1018 as further relevant data becomes available.) The model training component 1020 may be embodied at least in part by the computer processor 1014 and one or more application programs stored in the program memory 1016. Thus, the training of the predictive model component 1018 by the model training component 1020 may occur in accordance with program instructions stored in the program memory 1016 and executed by the computer processor 1014.

In addition, the computer system 1000 may include an output device 1022. The output device 1022 may be coupled to the computer processor 1014. A function of the output device 1022 may be to provide an output that is indicative of (as determined by the trained predictive model component 1018) particular performance metrics, automatically flagged electronic records, etc. The output may be generated by the computer processor 1014 in accordance with program instructions stored in the program memory 1016 and executed by the computer processor 1014. More specifically, the output may be generated by the computer processor 1014 in response to applying the data for the current simulation to the trained predictive model component 1018. The output may, for example, be a binary value, a numerical estimate, a ranked list, and/or likelihood within a predetermined range of numbers. In some embodiments, the output device may be implemented by a suitable program or program module executed by the computer processor 1014 in response to operation of the predictive model component 1018.

Still further, the computer system 1000 may include an analytics decision model module 1024. The analytics decision model module 1024 may be implemented in some embodiments by a software module executed by the computer processor 1014. The analytics decision model module 1024 may have the function of rendering a portion of the display on the output device 1022 and/or routing certain electronic records. Thus, the analytics decision model module 1024 may be coupled, at least functionally, to the output device 1022 and/or a workflow router. In some embodiments, for example, the analytics decision model module 1024 may report results and/or predictions by routing, to an underwriter 1028 via an analytics decision model platform 1026, a results log, and/or automatically generated subset of existing association review recommendations generated by the predictive model component 1018. In some embodiments, this information may be provided to the underwriter 1028 who may also be tasked with determining how to proceed and/or whether or not the results may be improved (e.g., by further adjusting an existing insurance policy and/or making recommendations about the predictive model 1018).

Thus, embodiments may provide an automated and efficient way to identify which existing insurance policies should undergo a supplemental underwriting evaluation. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

According to some embodiments, analytics decision model may generate a model score associated with an existing insurance policy. This information may then be used to rank all policies by score and existing insurance policies may be grouped into ten groups of substantially equal business. Moreover, an underwriting decision can be calculated for each decile and results may be compared (e.g., to evaluate and/or improve the results of an analytics decision model for existing insurance policies).

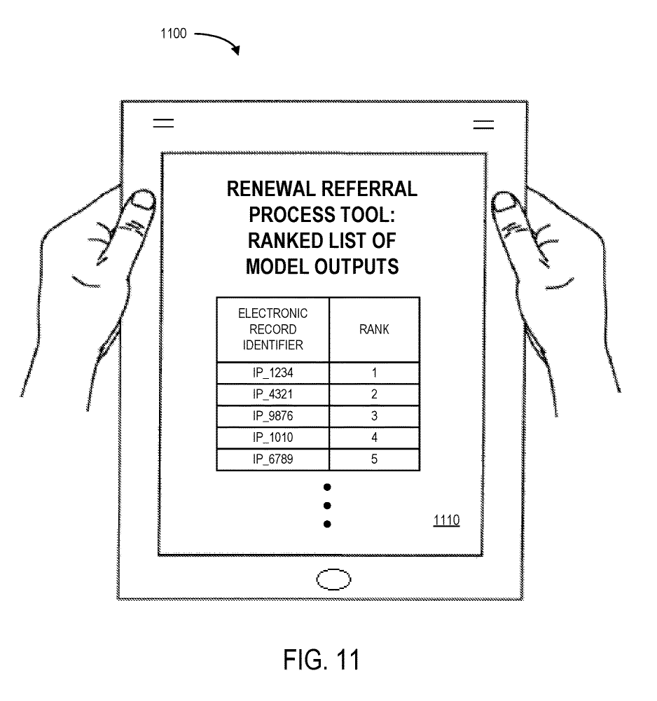

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of communication addresses, embodiments may instead be associated with other types of communications (e.g., chat implementations, web-based messaging, etc.). Similarly, although a certain types of record characteristic values were described in connection some embodiments, other types of data might be used instead. Still further, the displays and devices illustrated herein are only provided as examples, and embodiments may be associated with any other types of user interfaces. For example, FIG. 11 illustrates a handheld tablet computer 1100 displaying analytics decision model ranked list display 1110 according to some embodiments. The analytics decision model ranked list display 1110 might include user-selectable graphical data providing information about electronic records (and existing association review process related information) that can be selected and/or modified by a user of the handheld computer 1100.

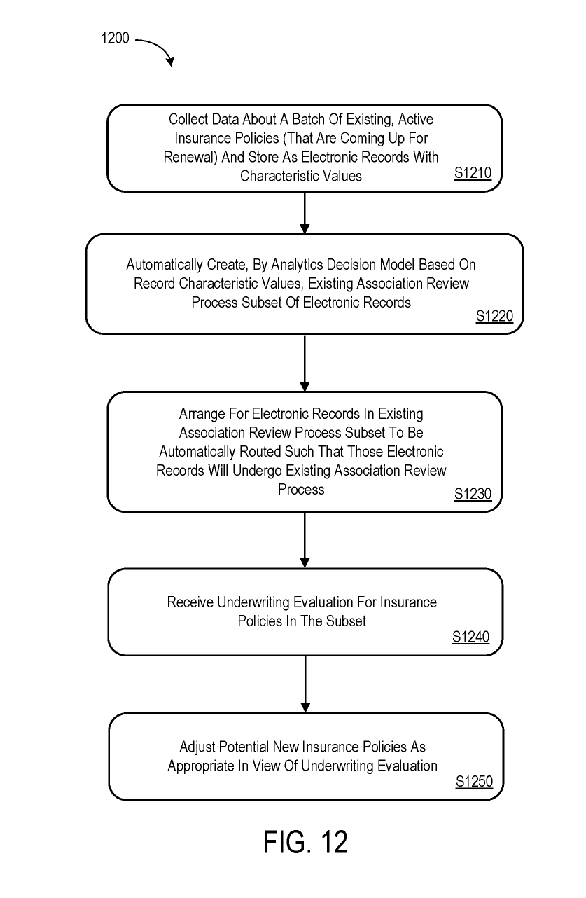

Note that embodiments described herein might be used in connection with a number of different types of business process flows. For example, FIG. 12 illustrates an overall process 1200 in accordance with some embodiments. At S1210, information about a batch of existing, active policies, insureds, businesses, etc. may be collected during an insurance renewal process. This information might be gathered, for example, via interviews, telephone calls, web-based forms, etc. At S1220, the system may automatically create (using, for example, any of the analytics decision models and/or record characteristics described herein) an existing association review process subset of insurance policies. Based on this subset, the records associated with those existing insurance policies may be automatically routed for underwriting evaluation at S1230. Those policies may then undergo the underwriting review process. For example, at S1240 the underwriter may adjust one or more insurance policy parameters, such as a premium, deductible, endorsements, etc. if appropriate based on the levels of risk associated with the insured. Indications of the adjusted parameters may then be transmitted to the existing insured and the existing insurance policies may be adjusted at S1250 (e.g., via an agent, web page, telephone call, etc.). In this way, appropriate insurance policy parameters may be assigned to an existing insurance policy as appropriate in view of an insured, industry, etc. Note that the indications of the adjusted parameters made by an underwriter might be transmitted directly to the existing insured or instead be provided via an insurance agent, a sales representative, a customer service manager, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to automatically identify electronic records to be routed to an existing association review process for an enterprise via an automated back-end application computer server, comprising:
(a) at least one internal data source storing data collected by the enterprise;
(b) at least one third-party data source external to the enterprise;
(c) a data store containing a set of electronic records created in accordance with data from both the internal data source and the third-party data source, each electronic record representing an existing risk association with an entity, wherein each electronic record contains a record identifier and a set of record characteristic values, including at least one record characteristic value collected during the existing risk association;
(d) the back-end application computer server, coupled to the data store, programmed to:
(i) access the set of electronic records in the data store,
(ii) automatically create, by an analytics decision model based at least in part on the record characteristic values, a subset of the set of electronic records for the existing association review process,
(iii) transmit an indication representing the existing association review process subset in connection with an interactive user interface display, and
(iv) arrange for electronic records in the existing association review process subset to be automatically routed such that those electronic records will undergo the existing association review process; and
(e) a communication port coupled to the back-end application computer server to facilitate an exchange of electronic messages, via a distributed communication network, supporting the interactive user interface display and the routing of electronic records as appropriate.

2. The system of claim 1, wherein the automated back-end application computer server is further programmed to execute record suppression logic to remove or rearrange at least some of the electronic records from the existing association review process subset based on a previously performed existing association review process.

3. The system of claim 1, wherein existing association review process score values are generated to create a ranked list of existing risk associations.

4. The system of claim 1, wherein each entity is associated with an existing insured and the existing risk association is an existing insurance policy up for renewal.

5. The system of claim 4, wherein the existing association review process comprises an underwriting evaluation of the existing insurance policy.

6. The system of claim 5, wherein existing association review process score values are generated to create a ranked list of existing insurance policies and the score values are not provided via the interactive user interface display.

7. The system of claim 6, wherein at least some of the set of record characteristic values include at least two of: (i) loss performance, (ii) building information, (iii) vehicle information, (iv) employee information, (v) driver information, (vi) a measure of complexity, (vii) an indicator of change over time, (viii) geography information, (ix) billing information, and (x) payment information.

8. The system of claim 1, wherein each electronic record is associated with a record identifier and a communication address, and the sets of record characteristic values are collected via at least one of: (i) sending a communication to a communication address and receiving, from a party associated with an electronic record having that communication address, a response to the communication, (ii) a postal mailing automatically generated by a distribution center, (iii) a postal mailing received by the distribution center, (iv) an email automatically generated by an email server, (v) information provided a web interface, (vi) an interactive voice response system associated with a telephone call center, (vii) a chat application that interacts with a party in substantially real time, and (viii) a video link.

9. The system of claim 1, wherein, after the existing association review processes are performed, the back-end application computer server is further to periodically monitor performance outcomes and automatically adjust the analytics decision model.

10. The system of claim 9, wherein performance outcomes are associated with at least one of: (i) a do not renew decision, (ii) endorsement activity, (iii) a renew per existing policy indication, and (iv) a renew with changes indication.

11. A computerized method to automatically identify electronic records to be routed to an existing association review process for an enterprise via an automated back-end application computer server, comprising:
accessing a data store containing a set of electronic records created in accordance with data from both an internal data source, storing data collected by the enterprise, and a third-party data source external to the enterprise, each electronic record representing an existing risk association with an entity, wherein each electronic record contains a record identifier and a set of record characteristic values, including at least one record characteristic value collected during the existing risk association;
automatically creating, by an analytics decision model based at least in part on the record characteristic values, a subset of the set of electronic records for the existing association review process;
transmitting an indication representing the existing association review process subset in connection with an interactive user interface display; and
arranging for electronic records in the existing association review process subset to be automatically routed such that those electronic records will undergo the existing association review process.

12. The method of claim 11, wherein the automated back-end application computer server is further programmed to execute record suppression logic to remove or rearrange at least some of the electronic records from the existing association review process subset based on a previously performed existing association review process.

13. The method of claim 11, wherein each entity is associated with an existing insured, the existing risk association is an existing insurance policy up for renewal, and the existing association review process comprises an underwriting evaluation of the existing insurance policy.

14. The method of claim 11, wherein at least some of the set of record characteristic values include at least two of: (i) loss performance, (ii) building information, (iii) vehicle information, (iv) employee information, (v) driver information, (vi) a measure of complexity, (vii) an indicator of change over time, (viii) geography information, (ix) billing information, and (x) payment information.

15. The method of claim 11, wherein each electronic record is associated with a record identifier and a communication address, and the sets of record characteristic values are collected via at least one of: (i) sending a communication to a communication address and receiving, from a party associated with an electronic record having that communication address, a response to the communication, (ii) a postal mailing automatically generated by a distribution center, (iii) a postal mailing received by the distribution center, (iv) an email automatically generated by an email server, (v) information provided a web interface, (vi) an interactive voice response system associated with a telephone call center, (vii) a chat application that interacts with a party in substantially real time, and (viii) a video link.

16. The method of claim 11, wherein, after the existing association review processes are performed, the back-end application computer server is further to periodically monitor performance outcomes and automatically adjust the analytics decision model.

17. The method of claim 16, wherein performance outcomes are associated with at least one of: (i) a do not renew decision, (ii) endorsement activity, (iii) a renew per existing policy indication, and (iv) a renew with changes indication.

18. A non-tangible, computer-readable medium storing instructions, that, when executed by a processor, cause the processor to perform a method to automatically identify electronic records to be routed to an existing association review process for an enterprise via an automated back-end application computer server, the method comprising:
accessing a data store containing a set of electronic records created in accordance with data from both an internal data source, storing data collected by the enterprise, and a third-party data source external to the enterprise, each electronic record representing an existing risk association with an entity, wherein each electronic record contains a record identifier and a set of record characteristic values, including at least one record characteristic value collected during the existing risk association;
automatically creating, by an analytics decision model based at least in part on the record characteristic values, a subset of the set of electronic records for the existing association review process;
transmitting an indication representing the existing association review process subset in connection with an interactive user interface display; and
arranging for electronic records in the existing association review process subset to be automatically routed such that those electronic records will undergo the existing association review process.

19. The medium of claim 18, wherein each entity is associated with an existing insured, the existing risk association is an existing insurance policy up for renewal, and the existing association review process comprises an underwriting evaluation of the existing insurance policy.

20. The method of claim 19, wherein each electronic record is associated with a record identifier and a communication address, and the sets of record characteristic values are collected via at least one of: (i) sending a communication to a communication address and receiving, from a party associated with an electronic record having that communication address, a response to the communication, (ii) a postal mailing automatically generated by a distribution center, (iii) a postal mailing received by the distribution center, (iv) an email automatically generated by an email server, (v) information provided a web interface, (vi) an interactive voice response method associated with a telephone call center, (vii) a chat application that interacts with a party in substantially real time, and (viii) a video link.
